(19) United States
(12) Patent Application Publication
(10) Pub. No.: US 2018/0117620 A1
(43) Pub. Date: May 3, 2018

(54) SLOT DIE BOUNDARY LAYER REMOVAL TECHNIQUES

(71) Applicant: Delta Industrial Services, Inc., Minneapolis, MN (US)

(72) Inventor: Thomas J. Forbes, Minneapolis, MN (US)

(21) Appl. No.: 15/340,209

(22) Filed: Nov. 1, 2016

(51) Int. Cl. B05C 5/02; B05C 21/00; B05C 1/08; B05D 3/04

(52) U.S. Cl. CPC B05C 5/0254; B05D 3/0493; B05C 1/0826; B05C 21/00

(57) ABSTRACT

This document discusses apparatus and methods for removing boundary air of a web that can interfere with slot die coating of a surface of the web. In an example, an apparatus for removing boundary air that can interfere with slot die coating a web can include a blade bar configured to attach adjacent an up-web side of a slot die vacuum box. The blade bar can include a channel configured to extend across a width of web, the channel including two sidewalls each having a surface configured to allow the web to pass between the surface and a machine roller with a consistent gap, a distribution chamber pneumatically coupled to the channel, and a vacuum connector configured to allow a source of vacuum to couple with the blade bar and apply vacuum to the vacuum distribution chamber.

### TECHNICAL FIELD

This application relates generally to web processing, and more particularly, to methods and apparatus for removing boundary layer air for slot die processes.

### BACKGROUND

Slot die web processing can allow a continuously moving web to be coated with various materials in a continuous manufacturing operation. Manufacturing efficiencies can be realized by using wider webs and processing the web at higher speeds. However, as a web moves faster, air disturbances can cause blemishes in the coated web as air near the surface of the moving web gets trapped between the web surface and the material being applied by the slot die, thus, limiting a top web speed of the slot die coating operation.

### SUMMARY

This document discusses apparatus and methods for removing boundary air of a web that can interfere with slot die coating of a surface of the web. In an example, an apparatus for removing boundary air of a moving web can include a blade bar configured to attach adjacent an up-web side of a slot die vacuum box. The blade bar can include a channel configured to extend across a width of web, the channel including two sidewalls each having a surface configured to allow the web to pass between the surface and a machine roller with a consistent gap, a distribution chamber pneumatically coupled to the channel, and a vacuum connector configured to allow a source of vacuum to couple with the blade bar and apply vacuum to the vacuum distribution chamber.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their equivalents.

### BRIEF DESCRIPTION OF THE DRAWINGS

FIG. 1A illustrates a cross-section view of a slot die system 100 including an example boundary air removal apparatus 101 according to the present subject matter.

FIG. 1B illustrates generally a close-up view of the example boundary air removal apparatus 101 in FIG. 1A.

FIG. 2A illustrates generally a second cross-section view of a boundary air removal apparatus 201 according to the present subject matter.

FIG. 2B illustrates generally a cut-away view of an example blade bar 212 of an example boundary air removal apparatus 201.

FIG. 3 illustrates generally an example method of operating a boundary air removal apparatus according to various examples of the present subject matter.

### DETAILED DESCRIPTION

The present inventor has recognized methods and apparatus that can alleviate issues that can interfere in applying materials via a slot die at high speed. As discussed above, slot dies can be very useful in applying materials to a continuously moving web in a very consistent layer. As slot die processing has matured, vacuum boxes have been mounted just upstream of the slot die to allow several manufacturing improvements. One improvement is the removal of air traveling with the moving web that at higher web speeds that can get trapped between the web surface and the material being applied by the slot die. The trapped air can be manifest as bubbles and typically renders the web product as waste. Thus, a vacuum box can be used to remove the air and can actually cause a little vacuum to develop between the web surface and the slot die material such that as the slot die material exits the slot die, the material is sucked toward the web surface. A second improvement realized with the use of a vacuum box is that adjustment of the vacuum pressure of the vacuum box can be used to adjust certain qualities of the applied material such as thickness and coverage width, in certain examples.

Development of the slot die vacuum box appears to have matured and has allowed slot die applications to run at significantly higher speed than without the vacuum box. However, even a vacuum box cannot prevent the same “bubbles” to appear as the web runs at even faster speeds. The inventor recognized that as the web moves faster and faster, so too does boundary layer air near the surface of the web. The momentum of the boundary air as the web increases in speed can cause significant turbulence within the vacuum box. Without increased vacuum pressure, the boundary layer air momentum and the induced turbulence can reach the interface of the vacuum box and the slot die disrupting the slot die material application. However, increasing the vacuum pressure at the higher speed to alleviate the boundary air momentum and turbulence from reaching the vacuum box slot die interface can also suck the material exiting the slot die into the vacuum box disrupting the slot die application of the material at the higher speed.

Thus, with a vacuum box alone, it appears that the maximum speed a web can be processed at is a speed where the vacuum pressure of the vacuum box can prevent the boundary air momentum and induced turbulence from reaching the interface of the vacuum box and the slot die, and does not suck the material exiting the slot die into the vacuum box.

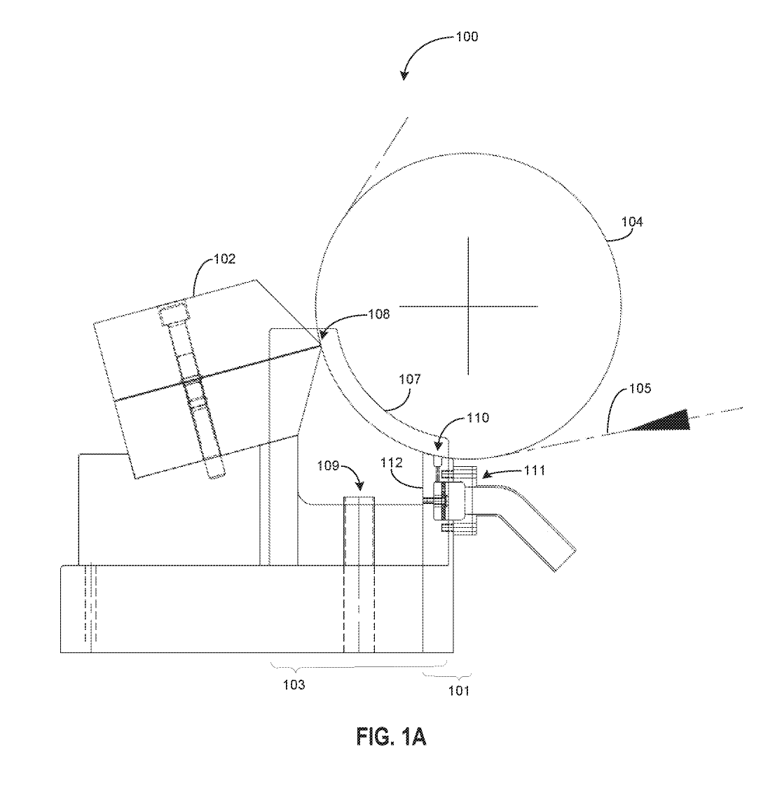

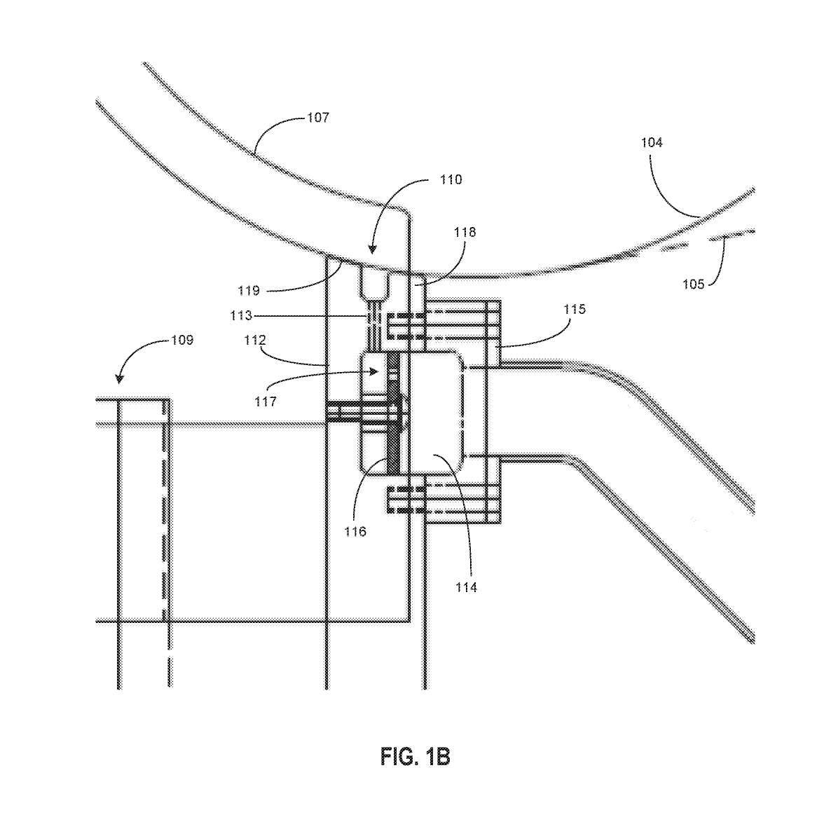

FIG. 1A illustrates a cross-section view of a slot die system 100 including an example boundary air removal apparatus 101 according to the present subject matter. FIG. 1B illustrates generally a close-up view of the example boundary air removal apparatus 101 in FIG. 1A. In certain examples, the slot die system 100 can include a slot die 102, a vacuum box 103 and an example boundary air removal apparatus 101. In certain examples, the slot die system 100 can be mounted adjacent a machine roller 104 of a larger web system. The machine roller 104 can be an idler roller, a driven roller or some other type machine roller that provides backing support to the web 105 as the web 105 moves past the slot die 102. The machine roller 104 can support the moving web 105 as the slot die 102 applies a coating material to a surface 106 of the web 105. The slot die 102 can provide a conduit for applying a coating material to a surface 106 of the web 105. Unlike curtain coaters that rely on gravity to move the coating material from the dispensing port of the curtain coater to the surface of the material to be coated, a slot die 102 can be placed in very close proximity to the web surface 106 and can generally dispense and coat the web surface 106 at any point about the machine roller 104, barring physical interferences, of course.

In general, the vacuum box 103 can include a hood 107 that can substantially, but not completely, encloses a length of web surface 106 entering the slot die interface 108. The hood 107 can include a port 109 for pulling a vacuum on the interior of the hood 107. In certain examples, the hood 107 can be positioned immediately adjacent the slot die interface 108. In some examples, the hood 107 can enclose the slot die interface 108.

As discussed above, running a web faster can provide more efficient production. However, as web speed increases, air can be carried with the traveling web and can cause turbulence near the surface of the web at the application interface of the slot die even with a vacuum box. At certain speeds, the turbulence can cause air to get trapped between the coating material and the web surface resulting in, generally, lower quality or waste product. Again, the faster the web speed, the more vacuum is applied to the vacuum box to maintain coating quality, and the less control of the coating process via vacuum adjustment.

The boundary air removal apparatus 101 can span the width of the web 105 and can be positioned or attached near the web entrance of the vacuum hood 107. The boundary air removal apparatus 101 can expose a vacuum channel 110 across the width of the web surface 106 to remove and prevent boundary air from entering the vacuum box 103. In certain examples, the boundary air removal apparatus can include a vacuum port 111 and a separate vacuum source can be applied to the boundary air removal apparatus 101 to remove boundary air traveling with the web 105, especially at higher speeds. In certain examples, the vacuum applied to the boundary air removal apparatus 101 can be set just short of a negative pressure that would catastrophically separate the moving web 105 from the machine roller 104.

In certain examples, the boundary air removal apparatus 101 can include manifold or blade bar 112 that can be mounted to or attached adjacent the up-web side of the vacuum box 103. The blade bar 112 can include a channel 110 with an open end configured to extend across a width of a web 105. The blade bar 112 can include a pair of sidewalls 118 that extend from a bottom of the channel 110 to the open end of the channel 110. Each sidewall 118 can include an outward-facing surface 119. In operation, the web 105 can pass between the machine roller 104 and each outward-facing sidewall surface 119. The bottom, or closed end, of the channel 110 can include a number of ports 113 connecting the channel to a distribution chamber 114 of the blade bar 112. The distribution chamber 114 can include a vacuum connector 115 for connecting a vacuum source to the blade bar 112. In certain examples, the distribution chamber 114 can include a distribution plate 116 that can partially separate the vacuum source side of the distribution chamber 114 from the channel side of the distribution channel 114. The distribution plate 116 can include a number of openings 117 distributed along the length of the distribution plate 116. The openings 117 in the distribution plate 116 can be design to restrict air flow and to distribute vacuum pressure more evenly along the length of the channel side of the distribution plate 116 and in turn along the length of the channel 110. In certain examples, the distribution plate 116 can be mounted with a fastener and a stand-off to a side of the distribution chamber 114.

In certain examples, several vacuum connectors 115 can be distributed along a length of the distribution chamber 114 to assist in distributing vacuum pressure more evenly along the length of the channel 110. In certain examples, the vacuum source for the boundary air removal apparatus 101 can be separate from the vacuum source for the vacuum box 103.

An unexpected benefit of adding a boundary air removal apparatus as discussed above is an improved ability to deal with web splices. Without a boundary air removal apparatus, the vacuum box is position adjacent the machine roller with very little clearance for the web to enter the vacuum box and to exit the vacuum box. Webs can often have splices, such as butt splices that were made by a preceding process. Splice can often disrupt a slot coating process by getting caught entering or exiting the vacuum box, or, if noticed in advance, slowing the process down to adjust the clearance to allow the splice to pass and then readjusting the clearance to allow for most efficient processing. One solution is to position the vacuum box with sufficient clearance to allow the splices to pass, however, as more clearance is allowed at the entrance and exit of the vacuum box, the more vacuum is necessary to remove the addition air flow allowed by the increased clearance and the more turbulence within the vacuum box. Each of these detrimental effects of increasing the clearance increases costs and reduces the control window for the process.

When a boundary air removal apparatus is added to a slot die and vacuum box system, clearance of the web box can be increased without significant change in process quality speed or vacuum capacity of the vacuum box, because the boundary air removal apparatus can prevent additional air flow from reaching the entrance to the vacuum box.

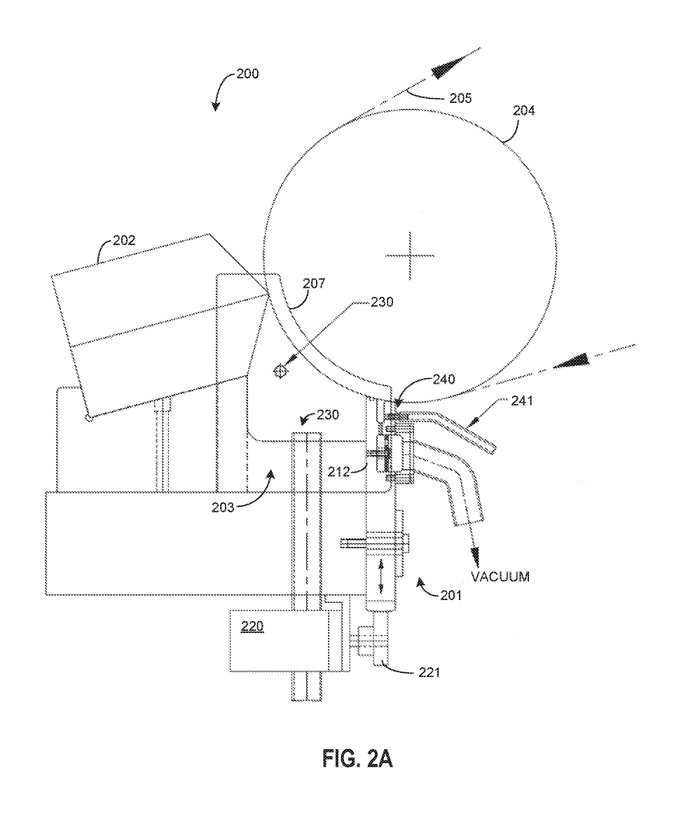

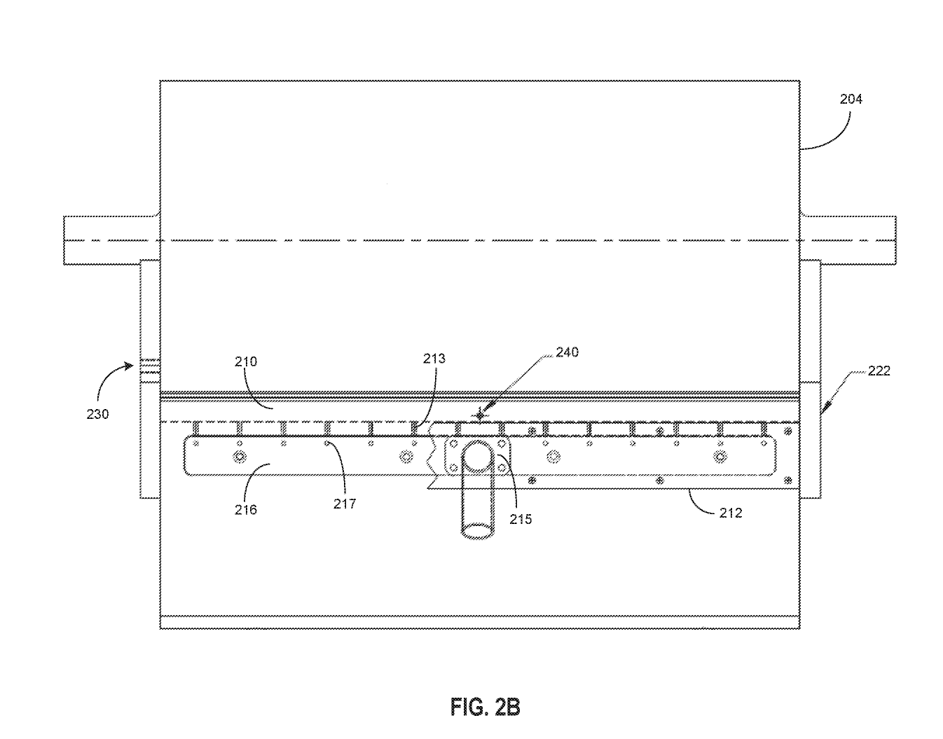

FIG. 2A and 2B illustrate generally a slot die system 200 including an example boundary air removal apparatus 201. The system can include the boundary air removal apparatus 201, a vacuum box 203, a slot die 202, a machine roller 204 and a web 205. FIG. 2A illustrates generally a cross-section view of the boundary air removal apparatus 201 according to the present subject matter. In certain examples, operation of the slot die system 200 at top speed can represent the most efficient use of the system. In certain examples, such operation can include positioning the blade bar 212 of the boundary air removal apparatus 201 as close as possible to the web 205. Such positioning can cause issues when a web splice passes through the slot die area. In certain examples, the boundary air removal system 201 can include a motion control system for positioning the blade bar 212 or adjusting the gap between blade bar 212 and the machine roller 204. In certain examples, the motion system can include a positioning actuator such as a servo motor 220 or a linear solenoid. In the illustrated system of FIG. 2A, the blade bar 212 of the boundary air removal system 201 can be mounted to a slide system (not shown) allowing the blade bar 212 to be moved vertically as illustrated. The blade bar 212. can then rest on a cam mounted to the servo motor 220. In certain examples, where the blade bar is at a different position around the machine roller 204, the blade bar 212 can be spring loaded to ride in the cam. In some examples, as a splice is detected, the motion control system can rotate the cam to open the gap between the blade bar 212 and the machine roller 204 as the splice passes and then can further rotate the cam to close the gap and resume top-speed slot die coating operation. In certain examples, having a mechanism for adjustment of gap between the blade bar 212 and the machine roller 204 can allow the larger web machine to coat webs of varying thickness with little delay for adjusting the slot die system 200.

In certain examples the vacuum box can include an optional sensor port 230. The sensor port 230 can allow the vacuum pressure of the vacuum box 207 to be monitored by a vacuum sensor. In certain examples, a sensor can be mounted directly to the sensor port 230. In some examples, a tube can connect the vacuum sensor to the sensor port 230. In some examples, the sensed vacuum can be used for feedback to maintain or modulate a desired vacuum pressure in the vacuum box 207.

In certain examples the boundary air removal system 201 can include an optional sensor port 240. The sensor port 240 can allow the vacuum pressure of the blade bar channel 210 to be monitored by a vacuum sensor. In certain examples, a sensor can be mounted directly to the sensor port 240. In some examples, a tube 241 can pneumatically couple the vacuum sensor to the sensor port 240. In some examples, the sensed vacuum can be used for feedback to maintain or modulate a desired vacuum pressure in the blade bar channel 210.

FIG. 2B illustrates generally a cut-away view of an example blade bar 212 of an example boundary air removal apparatus 201. The example boundary air removal apparatus is shown installed new a machine roller 204 with a portion of the hood 207 of a vacuum box 203 visible behind the example boundary air removal apparatus 201, including a sensor port 230 for the vacuum box 203. Visible portions of the blade bar 212 include end dams 222 to seal the ends of the channel 210, the channel 210, the distribution chamber 214, ports 213 pneumatically coupling the distribution chamber to the channel, a distribution plate 216, openings 217 in the distribution plate 216, a vacuum connector 215, and a sensor port 240 for the channel 210.

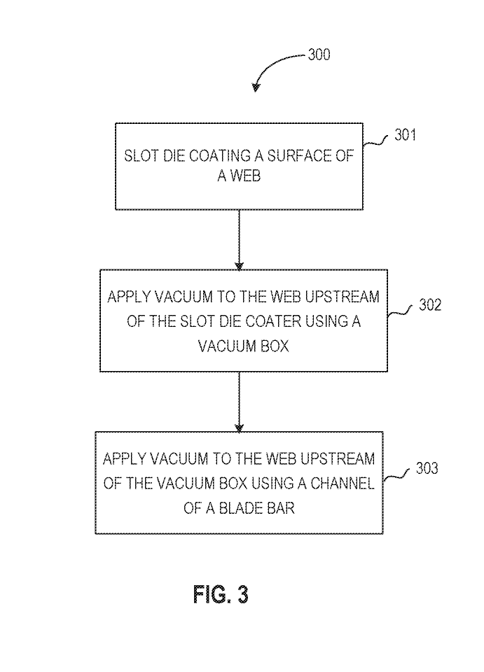

FIG. 3 illustrates generally an example method if operating a boundary air removal system according to the present subject matter. At 301, a surface of a web, such as a moving web, can be coated using a slot die. At 302, vacuum can he applied to the surface of the web up-stream from or at the interface of the slot die and the web using a vacuum box. The vacuum can assist in providing a consistent coating at various speeds of the web. At 303, vacuum can be applied to the surface of the web immediately up-stream from or adjacent to the vacuum box using a channel of a blade bar. The channel of the blade bar can remove a substantial amount of boundary air traveling with the web. Absent the blade bar, the boundary air can enter the vacuum box and cause turbulence that can result in air getting trapped in the coated web. Such trapped error can be detrimental to the quality of the coated web or can render the coated web a waste. In certain examples, the surface area of the web the channel overlays is quite small compared to the vacuum box, therefore, high vacuum can be applied to remove the boundary air without interrupting or displacing the moving web. With the boundary air removed from the traveling web, the vacuum box can be somewhat insulated from boundary air turbulence and the web can be coated at higher speeds while maintain coating consistency and quality.

The methods illustrated in this disclosure are not intended to be exclusive of other methods within the scope of the present subject matter. Those of ordinary skill in the art will understand, upon reading and comprehending this disclosure, other methods within the scope of the present subject matter. The above-identified embodiments, and portions of the illustrated embodiments, are not necessarily mutually exclusive. These embodiments, or portions thereof, can be combined. In various embodiments, the methods are implemented using a sequence of instructions which, when executed by one or more processors, cause the processor(s) to perform the respective method. In various embodiments, the methods are implemented as a set of instructions contained on a computer-accessible medium such as a magnetic medium, an electronic medium, or an optical medium.

The above detailed description is intended to be illustrative, and not restrictive. Other embodiments will be apparent to those of skill in the art upon reading and understanding the above description. The scope of the invention should, therefore, be determined with reference to the appended claims, along with the full scope of equivalents to which such claims are entitled.

What is claimed is:

1. An apparatus for removing boundary air that can interfere with slot die coating a web, the apparatus comprising:
a blade bar configured to attach adjacent an up-web side of a slot die vacuum box, the blade bar including
a channel configured to extend across a width of web, the channel including two sidewalls each having a surface, the blade bar configured to allow the web to pass between the respective surfaces of the two sidewalls and a machine roller with a consistent gap;
a distribution chamber pneumatically coupled to the channel; and
a vacuum connector configured to allow a source of vacuum to couple with the blade bar and apply vacuum to the vacuum distribution chamber.

2. The apparatus of claim 1, wherein the distribution chamber extends across the width of the web.

3. The apparatus of claim 1, including a plurality of individual ports configured to pneumatically couple the distribution chamber with the channel.

4. The apparatus of claim 1, including a distribution plate positioned to bisect the distribution chamber between the vacuum connector and the channel.

5. The apparatus of claim 4, wherein the distribution plate includes a plurality of openings configured to pneumatically couple a first section of the distribution chamber with a second portion of the distribution chamber.

6. The apparatus of claim 1, including a sensor port configured to pneumatically couple a vacuum sensor to the channel.

7. The apparatus of claim 1, including a motion system configured to move the blade bar relative to a surface of a machine roller to adjust a gap between the machine roller and the blade bar.

8. A slot die coating system configured for placement near a surface of a web machine roller, the system comprising:
a slot die coater configured to apply a layer of fluid material on a web at least partially wrapped about the web machine roller:
a vacuum box upstream from and adjacent the slot die coater, the vacuum box having an opening to ambient air extending across a width of the web and proximate a portion of the web that is at least partially wrapped about the web machine roller; and
a blade bar attached to an adjacent upstream side of the vacuum box and including a channel configured to extend across the width of web, the channel including two sidewalls each having a surface configured to allow the web to pass between the surface and the web machine roller with a consistent gap, the blade bar configured to remove boundary layer air traveling with the web from the web as the web enters the slot die coating system.

9. The system of claim 8, including a first vacuum source configured to couple to the vacuum box.

10. The system of claim 9, including a second vacuum source coupled to the blade bar.

11. The system of claim 8, wherein the blade bar includes a distribution chamber pneumatically coupled to the channel.

12. The system of claim 11, wherein the blade bar includes a vacuum connector configured to allow a source of vacuum to couple with the blade bar and apply vacuum to the vacuum distribution chamber.

13. The apparatus of claim 11, wherein the distribution chamber extends across the width of the web.

14. The apparatus of claim 11, including a plurality of individual ports configured to pneumatically couple the distribution chamber with the channel.

15. The apparatus of claim 11, including a distribution plate positioned configured to bisect the distribution chamber between the vacuum connector and the channel.

16. The apparatus of claim 15, wherein the distribution plate includes a plurality of holes configured to pneumatically couple a first section of the distribution chamber with a second portion of the distribution chamber.

17. A method of operating a slot die system, the method comprising:
coating a surface of a web with a layer of material using a slot die;
applying vacuum to the web upstream of the slot die to control application of a layer of material using a vacuum box; and
applying vacuum to the web upstream of the vacuum box using a channel of a blade bar to remove boundary layer air traveling with the web and to ameliorate disturbing air movement in the vacuum box due to boundary air entering the vacuum box with the web.

18. The method of claim 17, including applying vacuum to the channel via ports coupling the channel to a distribution chamber of the blade bar.

19. The method of claim 18, including distributing vacuum across a length of the distribution chamber using a distribution plate positioned to bisect the distribution chamber, the distribution plate including opening configured to restrict pneumatic flow between bisected portions of the distribution chamber.

20. The method of claim 17, including adjusting a gap between the web machine roller and the blade bar to accommodate a web splice passing the slot die using an actuator.

21. The method of claim 17, including receiving vacuum pressure feedback information from the channel and modulating a vacuum source pneumatically coupled to the distribution chamber based on the vacuum pressure feedback information.

22. The method of claim 17, wherein the web adjacent to the slot die is at least partially wrapped about a rotating web machine roller.
